(19) United States
(12) Patent Application Publication
(10) Pub. No.: US 2015/0153013 A1
(43) Pub. Date: Jun. 4, 2015

(54) LIGHT ADJUSTING FILM

(71) Applicant: BenQ Materials Corporation, Taoyuan County (TW)

(72) Inventors: Fung-Hsu WU, Taoyuan County (TW); Meng-Chieh CHOU, Taoyuan County (TW)

(21) Appl. No.: 14/534,172

(22) Filed: Nov. 6, 2014

(30) Foreign Application Priority Data
Nov. 29, 2013 (TW) 102143784

(51) Int. Cl. F21S 11/00; F21V 5/00

(52) U.S. Cl. CPC F21S 11/007; F21V 5/004; F21V 5/005

(57) ABSTRACT

The invention is related to a light adjusting film. The light adjusting film includes a transparent substrate, a plurality of micro lens structures on a light incident surface of the transparent substrate and a plurality of micro triangular prism structures on a light emitting surface of the transparent substrate. The curvature of the micro lens structures is in a range of 50 μm⁻¹ to 500 μm⁻¹, and the position of each of micro lens structures is corresponding to that of one or more of the micro triangular prism structures. By designing of the micro lens structures together with the triangular prism structures, sunlight can be used effectively so as to achieve energy saving performance.

### CROSS-REFERENCE TO RELATED APPLICATION

This application claims the priority benefit of Taiwanese application serial no. 102143784, filed on Nov. 29, 2013, the full disclosure of which is incorporated herein by reference.

### BACKGROUND

1. Technical Field

The present invention relates to a light adjusting film, which is used for adjusting the incident light and the emitting light. Especially, the light adjusting film is applied on windows or curtains.

2. Description of Related Art

Recently, with the raise of consciousness of energy saving, energy saving of building lighting has become a popular topic of research. In addition to utilize artificial lighting source to save energy, natural light is promoted extensively.

For increasing the utilization rate of sunlight, micro lens structures are usually used for concentrating sunlight inside of buildings. However, in this way, the micro lens structures only enhance the illumination of specific areas inside of the buildings and result in human eyes to feel uncomfortable. As a result, the present invention provides a combination design of micro lens structures for concentrating the incident light and micro triangular prism structures for redirecting the emitting light to the ceilings in a room so as to enhance the illumination of whole areas.

### SUMMARY

According to aforementioned reasons, the present invention is to provide a novel light adjusting film, which includes micro lens structures and micro triangular prism structures for utilizing sunlight more effectively and providing energy saving performance.

According to an aspect of the present invention, the light adjusting film includes a transparent substrate, a plurality of micro lens structures disposed on a light incident surface of the transparent substrate, and a plurality of micro triangular prism structures disposed on a light emitting surface of the transparent substrate. The curvature of the micro lens structures is in the range of 50 μm⁻¹ to 500 μm⁻¹, and the position of each micro lens structure is corresponding to that of one or more micro triangular prism structures.

According to an aspect of the present invention, the micro lens structures of the light adjusting film are formed of micro lenticular lenses, a micro lens array or the combination thereof.

According to an aspect of the present invention, the micro lens arrays is a linear array, a curved array or the combination thereof.

According to an aspect of the present invention, the width of the micro lens structures is in the range of 10 μm to 500 μm, and the height of the micro lens structures is in the range of 0.025 μm to 70 μm.

According to an aspect of the present invention, each of the micro triangular prism structures has a first side and a second side, and a first included angle between the first side of the micro triangular prism structures, and the transparent substrate is in the range of 40 degree to 90 degree.

According to an aspect of the present invention, a second included angle between the first side and the second side of the micro triangular prism structures is in the range of 20 degree to 60 degree.

According to an aspect of the present invention, the width of the micro triangular prism structures is in the range of 10 μm to 500 μm, and the height of the micro-triangular prism structures is in the range of 1 μm to 1500 μm.

According to an aspect of the present invention, each of micro lens structures is the same or different, and each of micro triangular prism structures is the same or different.

According to an aspect of the present invention, the micro lens structures or the micro triangular prism structures are arranged continuously or discontinuously.

According to an aspect of the present invention, the micro lens structures and the micro triangular prism structures are made of a material selected from the group consisting of a thermo curable material, a UV curable material and a combination thereof.

According to an aspect of the present invention, the material further includes an IR absorber, an UV absorber, an antifouling agent, an antibacterial agent or the combination thereof.

According to an aspect of the present invention, the micro lens structures or the micro triangular prism structures further comprise a coating layer disposed on the surface of the micro lens structures or on the micro triangular prism structures.

According to an aspect of the present invention, the coating layer is a functional layer selected from the group consisting of an adhesive layer, a hard coating layer, a low energy surface coating layer, an IR absorbing layer, an UV absorbing layer and a combination thereof.

According to an aspect of the present invention, the coating layer further includes an IR absorber, an UV absorber, an antifouling agent, an antibacterial agent or the combination thereof.

### BRIEF DESCRIPTION OF THE DRAWINGS

FIG. 1 shows a schematic diagram of a light adjusting film 100 of a preferred embodiment of the present invention.

FIG. 2 shows a schematic diagram of a light adjusting film 200 of a preferred embodiment of the present invention.

FIG. 3 shows a schematic diagram of a light adjusting film 300 of a preferred embodiment of the present invention.

FIG. 4 shows a schematic diagram of a light adjusting film 400 of a preferred embodiment of the present invention.

FIG. 5a shows a schematic diagram of a light adjusting film 500 of a preferred embodiment of the present invention.

FIG. 5b shows a cross-sectional schematic diagram of a light adjusting film 500 of a preferred embodiment of the present invention.

FIG. 6 shows a schematic diagram of a light adjusting film 600 of a preferred embodiment of the present invention.

FIG. 7 shows an enlarged view schematic diagram of a light adjusting film 700 of a preferred embodiment of the present invention.

FIG. 8 shows a cross-sectional schematic diagram of a light adjusting film 800 of a preferred embodiment of the present invention.

FIG. 9a shows a schematic diagram of a light adjusting film 900a of a preferred embodiment of the present invention.

FIG. 9b shows a schematic diagram of a light adjusting film 900b of a preferred embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

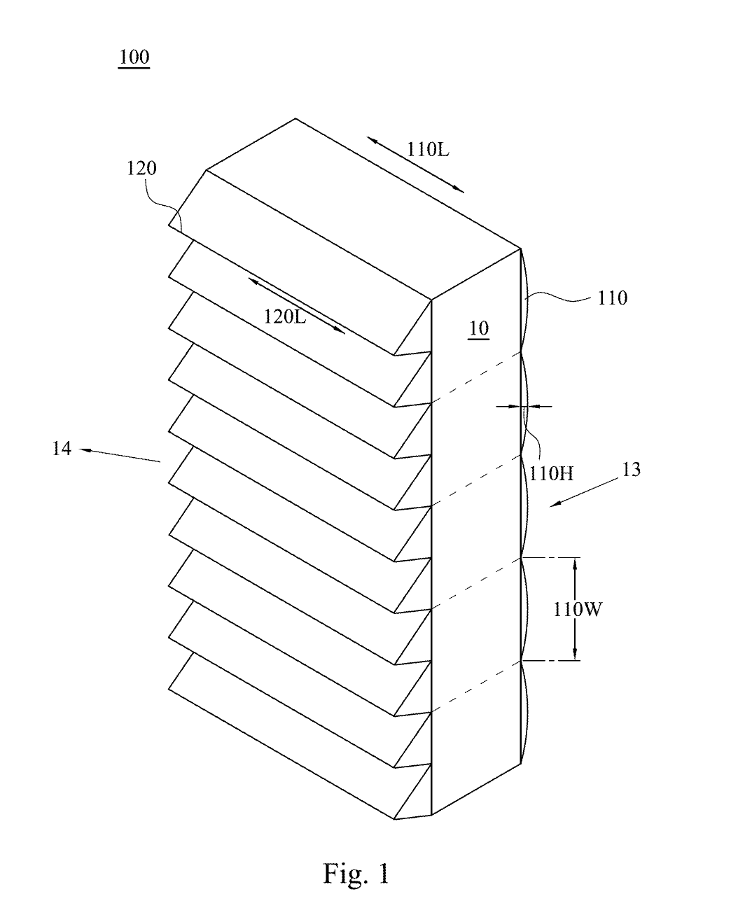

Referring to FIG. 1, a schematic diagram of a light adjusting film 100 of a preferred embodiment of the present invention is shown. FIG. 1 also shows the incident light 13 and the emitting light 14. The light adjusting film 100 includes a transparent substrate 10; a plurality of micro lens structures 110 disposed on a light incident surface of the transparent substrate 10; and a plurality of micro triangular prism structures 120 disposed on a light emitting surface of the transparent substrate 10.

For concentrating the incident light into the micro triangular prism structures at a preferred angle, so as to enhance the utilizing rate of incident light, the curvature of the micro lens structures is in the range of 50 μm⁻¹ to 500 μm⁻¹, and the position of each micro lens structure is corresponding to that of one or more micro triangular prism structures.

In the embodiment of the present invention, the curvature of the micro lens structures 110 is 130 μm⁻¹, and the position of each micro lens structure 110 is corresponding to that of two micro triangular prism structures 120.

In the light adjusting film of the present invention, the micro lens structures are formed of micro lenticular lenses, a micro lens array or the combination thereof. The micro lens structures are arranged continuously or discontinuously. Moreover, the width of the micro lens structures is in the range of 10 μm to 500 μm, and the height of the micro lens structures is in the range of 0.025 μm to 70 μm.

In the embodiment of the present invention, the micro lens structures 110 which are formed of micro lenticular lens. The micro lens structures are arranged continuously on the light incident surface of the transparent substrate 100. The width 110W of the micro lens structures 110 is 50 μm, and the height 110H of the micro lens structures 110 is 2.5 μm.

In addition, the micro lens structures 110 and the micro triangular prism structures 120 are arranged in parallel to each other in the embodiment of the present invention. The term “arranged in parallel to each other” as used herein refers to the long axis direction 110L of the micro lens structures 110 which is parallel to the long axis direction 120L of the micro triangular prism structures 120 as shown in FIG. 1.

The long axis direction of the micro lens structures and the long axis direction of the micro triangular prism structures can be but not limited to, perpendicular to each other or crossed at a specific included angle.

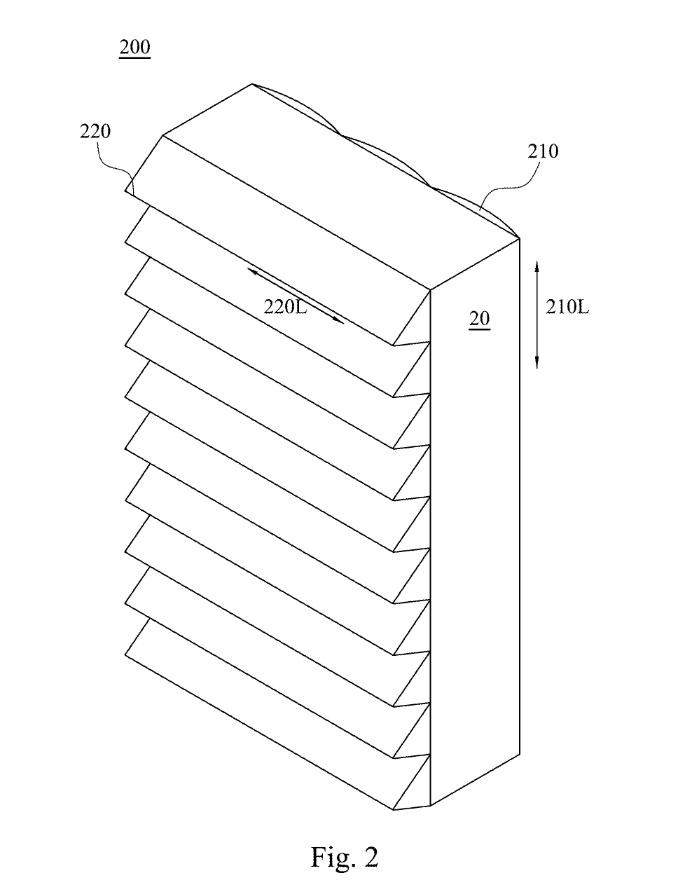

Referring to FIG. 2, a schematic diagram of a light adjusting film 200 of a preferred embodiment of the present invention is shown. In FIG. 2, the light adjusting film 200 includes a transparent substrate 20, a plurality of micro lens structures 210 disposed on a light incident surface of the transparent substrate 20, and a plurality of micro triangular prism structures 220 disposed on a light emitting surface of the transparent substrate 20. Moreover, the long axis direction 210L of the micro lens structures 210 is arranged in orthogonal to the long axis direction 220L of the micro triangular prism structures 220.

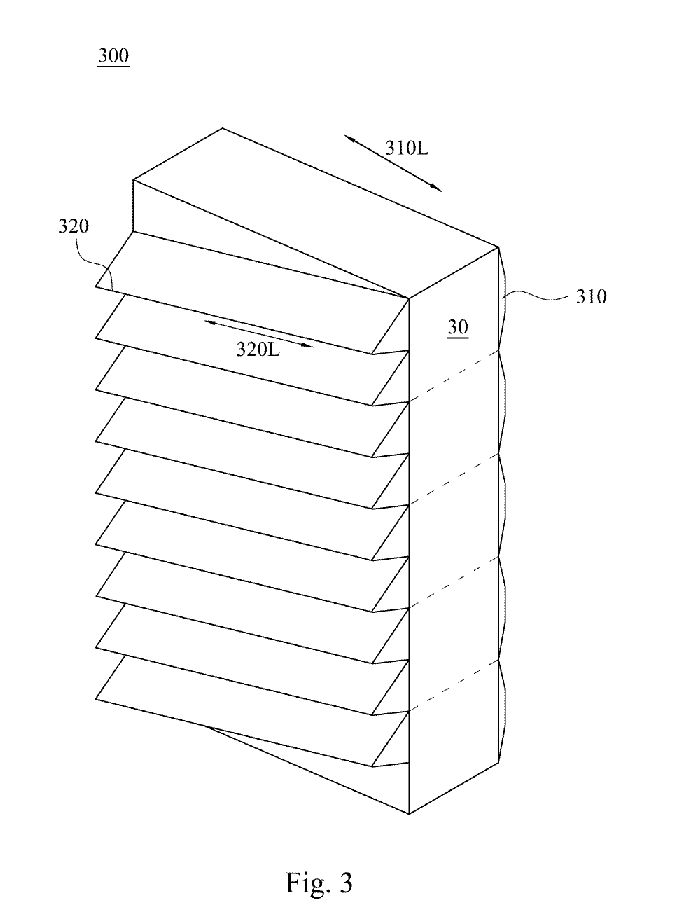

Referring to FIG. 3, a schematic diagram of a light adjusting film 300 of a preferred embodiment of the present invention is shown. In FIG. 3, the light adjusting film 300 includes a transparent substrate 30, a plurality of micro lens structures 310 disposed on a light incident surface of the transparent substrate 30, and a plurality of micro triangular prism structures 320 disposed on a light emitting surface of the transparent substrate 30. Moreover, the long axis direction 310L of the micro lens structures 310 and the long axis direction 320L of the micro-triangular prism structures 320 cross at an included angle.

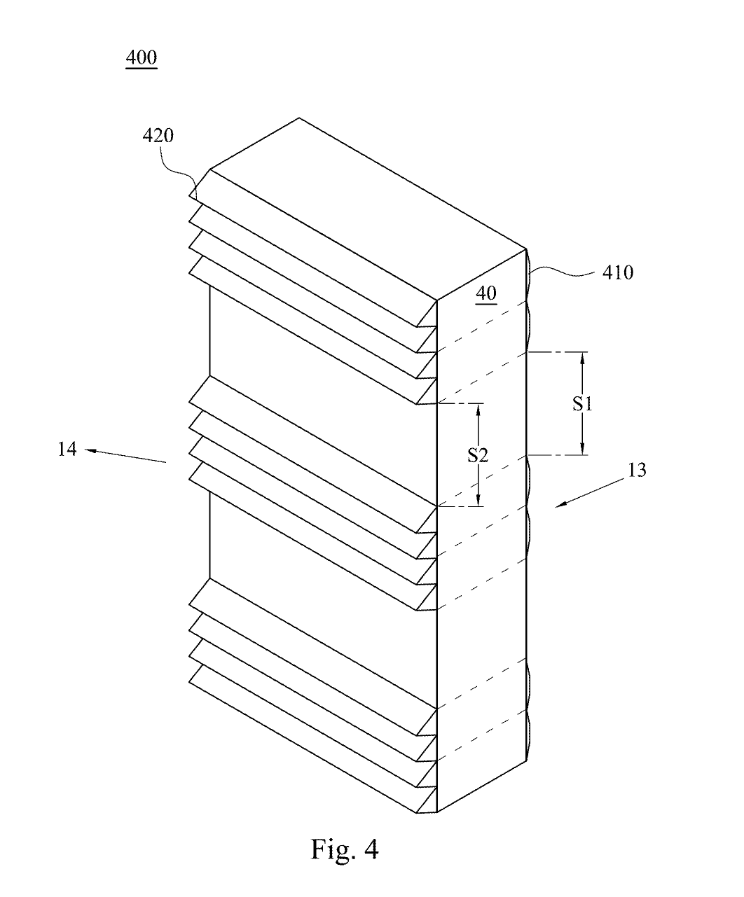

Referring to FIG. 4, a schematic diagram of a light adjusting film 400 of a preferred embodiment of the present invention is shown. The difference between the light adjusting film 400 and the light adjusting film 100 is the arrangement of the micro lens structures 410 and the micro triangular prism structures 420. The micro lens structures 410 are not fully arranged continuously, and the pitch S1 is existed between every two of micro lens structures 410. The micro triangular prism structures 420 are not fully arranged continuously, and the pitch S2 is existed between every four of micro triangular prism structures.

For concentrating the incident light into the micro triangular prism structures 420 at a preferred angle, the curvature of the micro lens structures 410 is 130 μm⁻¹, and the position of each micro lens structure 410 is corresponding to that of two micro triangular prism structures 420.

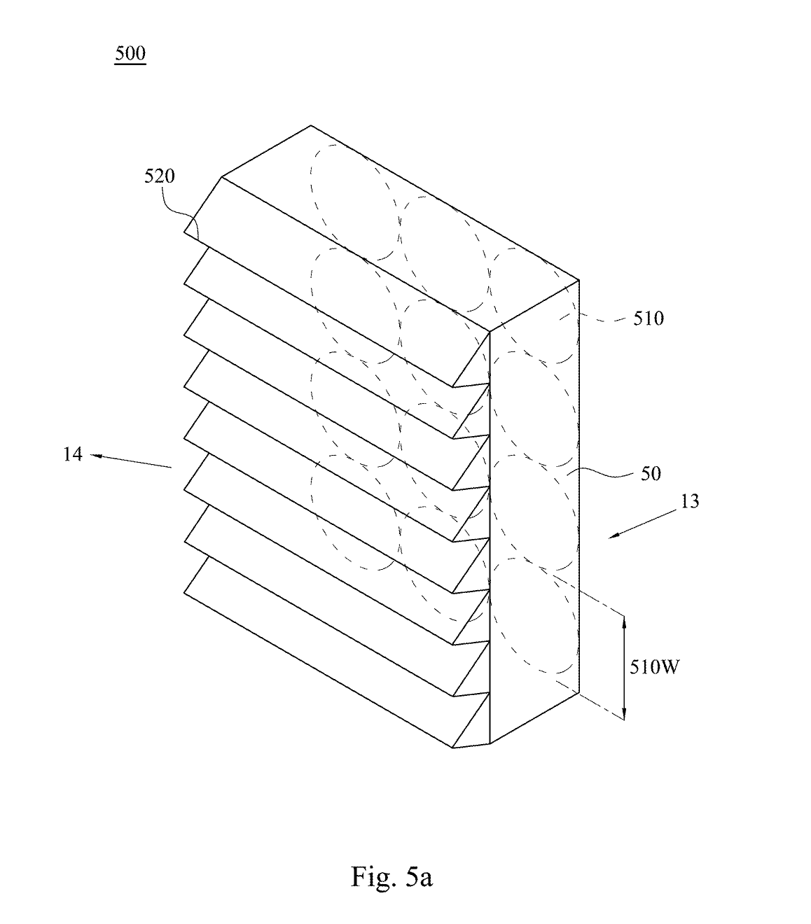

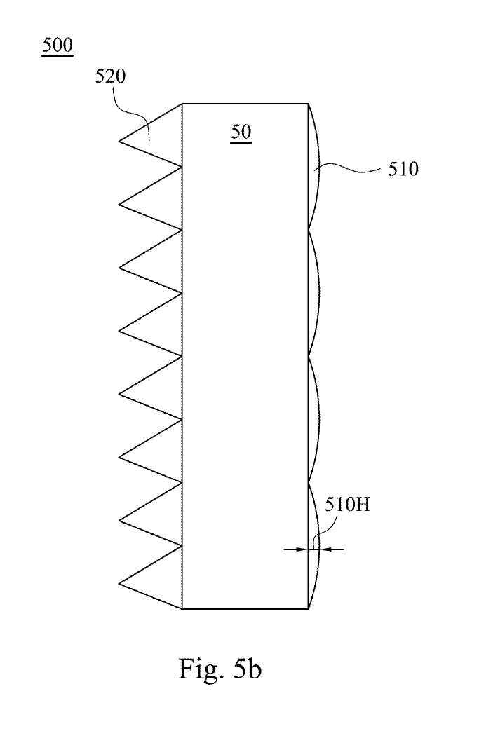

Referring to FIG. 5a, a schematic diagram of a light adjusting film 500 of a preferred embodiment of the present invention is shown. Referring to FIG. 5b, a cross-sectional schematic diagram of a light adjusting film 500 of a preferred embodiment of the present invention is shown. The difference between the light adjusting film 500, and the light adjusting film 100 is the micro lens structures 510 on the light incident surface of the transparent substrate 50. The micro lens structures 510 are formed of a micro lens array, such as linear array. In the array, each micro lens is arranged continuously on the light incident surface of the transparent substrate 50.

For concentrating the incident light 13 into the micro triangular prism structures 520 at a preferred angle so as to enhance the utilizing rate of incident light 13, the curvature of the micro lens structures 510 is 130 μm⁻¹, and the position of each micro lens structure 510 is corresponding to that of two micro triangular prism structures 520. The width 510W of the micro lens structure 510 is 50 μm, and the height 510H of the micro lens structure 510 is 2.5 μm. Besides, the micro lens structures are arranged in a linear array, but are not limited thereto. For example, the micro lens structures are arranged in a random order.

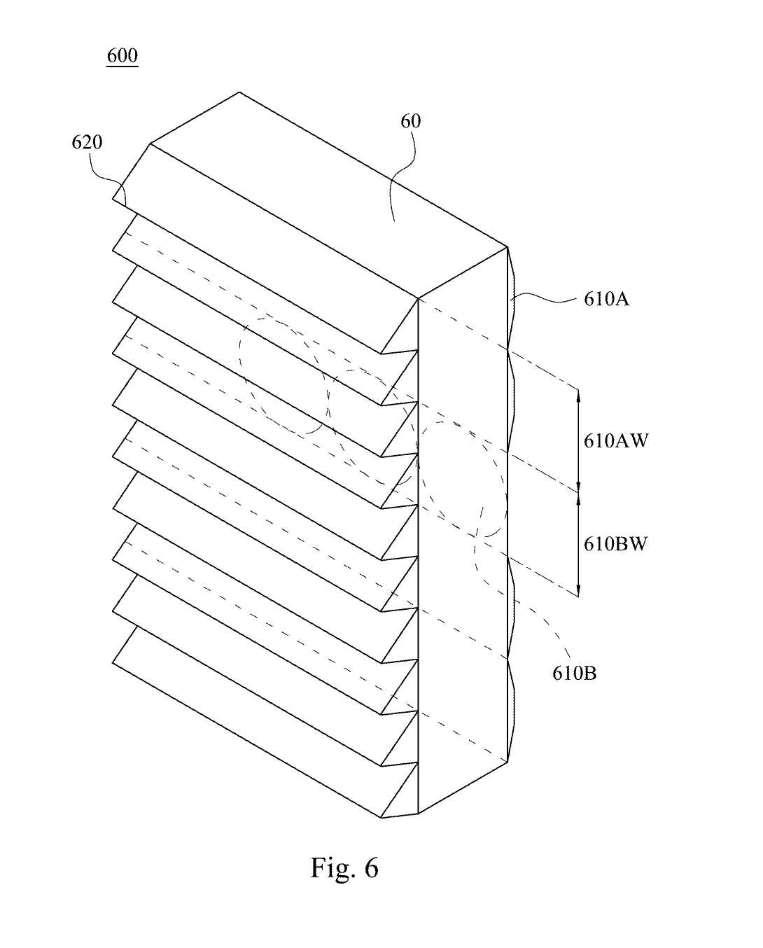

Referring to FIG. 6, a schematic diagram of a light adjusting film 600 of a preferred embodiment of the present invention is shown. The difference between the light adjusting film 600 and the light adjusting film 100 is the micro lens structures on the light incident surface of the transparent substrate 60. The micro lens structures are formed of a plurality of micro lenticular lens 610A and a micro lens array consisting of a plurality of micro lens 610B, wherein the micro lenticular lens 610A and the micro lens array are alternately arranged. For concentrating the incident light into the micro triangular prism structures 620 at a preferred angle so as to enhance the utilizing rate of the incident light, the curvature of the micro lenticular lens structures 610A is 130 μm⁻¹, and the curvature of the micro lens structures 610B is 130 μm¹. Moreover, the position of each micro lenticular lens 610A, and each micro lens structure 610B are corresponding to that of two micro triangular prism structures 620 respectively.

The micro lenticular lens 610A and the micro lens structures 610B are alternately arranged on the light incident surface of the transparent substrate 60, wherein the rows of the micro lenticular lens 610A and micro lens structures 610B are arranged in a ratio of 1:2 or 2:1. The width 610AW of the micro lenticular lens structures 610A is 50 μm, and the height 610AH of the micro lenticular lens structures 610A is 2.5 μm. The width 610BW of the micro lens structures 610B is 50 μm, and the height 610BH of the micro lens structures 610B is 2.5 μm.

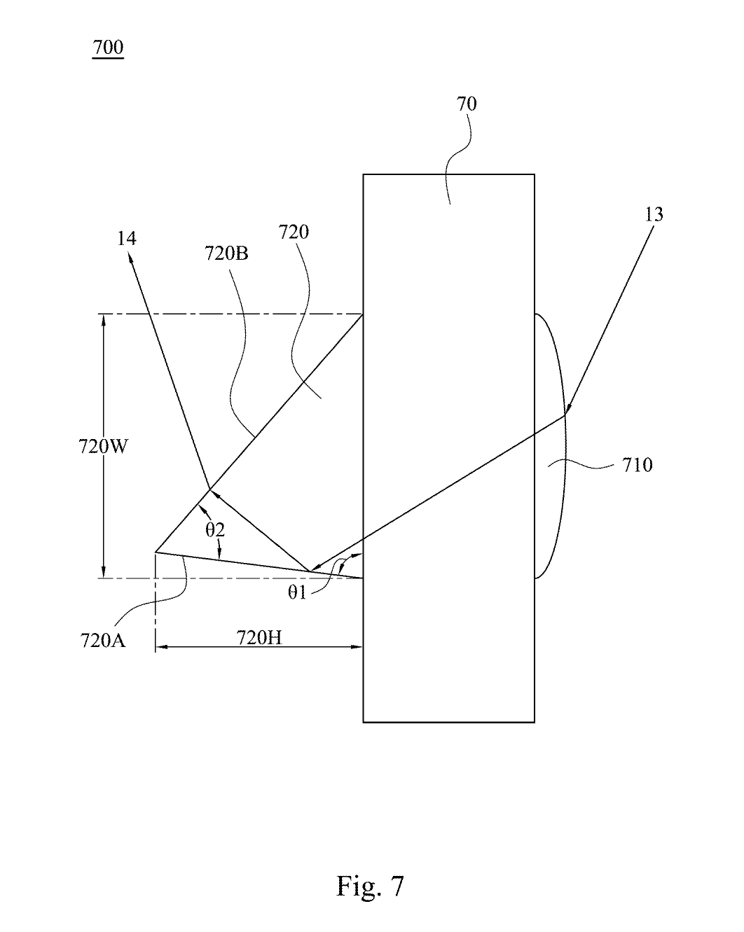

For illustrating a light passing through a light adjusting film in detail, please refer to an enlarged view schematic diagram of a light adjusting film 700 in FIG. 7. The light adjusting film 700 includes a transparent substrate 70, a plurality of micro lens structures 710 disposed on a light incident surface of the transparent substrate 70, and a plurality of micro triangular prism structures 720 disposed on a light emitting surface of the transparent substrate 70. After the incident light 13 transmit the micro lens structures 710 and the transparent substrate 70, the total internal reflection of it would occur at the first side 720A of the micro triangular prism structures 720. Finally, the light emit from the second side 720B of the triangular prism structures 720. For adjusting the direction of the emitting light 14, the first included angle θ1 between the first side 720A of the micro triangular prism structures 720 and the transparent substrate 70 is in the range of 40° to 90°. The second included angle θ2 between the first side 720A and the second side 720B of the micro triangular prism structures 720 is in the range of 20° to 60°. Moreover, the width 720W of the micro triangular prism structures 720 is 20 μm, and the height 720H of the micro triangular prism structures 720 is 35 μm.

In an embodiment of the present invention, the transparent substrate is selected from the group of polyethylene terephthalate (PET), polycarbonate (PC), acrylate resin, polymethyl methacrylate (PMMA), poly urethane (PU) and a combination thereof.

In an embodiment of the present invention, the micro lens structures and the micro triangular prism structures are made of a material selected from the group consisting of a thermo curable material, a UV curable material and a combination thereof. The thermo curable material or the UV curable material are, for example, such as acrylic resin, poly urethane resin, poly ester, silicon resin or epoxy resin. The material further includes an IR absorber, an UV absorber, an antifouling agent, an antibacterial agent or the combination thereof.

In addition, the micro lens structures or the micro triangular prism structures further comprise a coating layer disposed on the surface thereof. The coating layer is a functional layer selected from the group consisting of an adhesive layer, a hard coating layer, a low energy surface coating layer, an IR absorbing layer, an UV absorbing layer and a combination thereof.

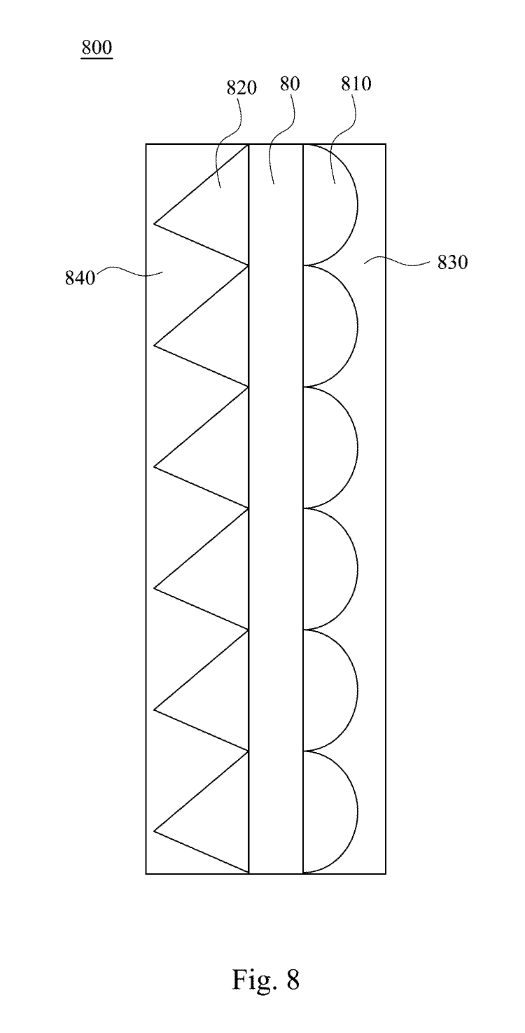

Referring to FIG. 8, a cross-sectional schematic diagram of a light adjusting film 800 of a preferred embodiment of the present invention is shown. The coating layer 830 disposed on the micro lens structures 810. The coating layer 840 disposed on the micro triangular prism structures 840. The coating layers 830 or 840 are disposed thereon according to the different functions of users need. In an embodiment of the present invention, the coating layer 830 is such as an adhesive layer to make the light adjusting film 800 to laminate to any substrate. The coating layer 840 is such as a hard coating layer to prevent the surface of the micro triangular prism structures 820 from scratch so as to reduce the light adjusting performance.

The adjusting film of the present invention can be arranged partially or completely on the transparent substrate. The term “partially” as used herein refers to “a stripe pattern”, “a chessboard-like pattern” or other patterns, but is not limited to. According to different requirements, users can choose different patterns to meet their need.

In addition, the light adjusting film of the present invention can be arranged on the transparent plate, for example, such as glass, acrylic sheet or curtains or windows.

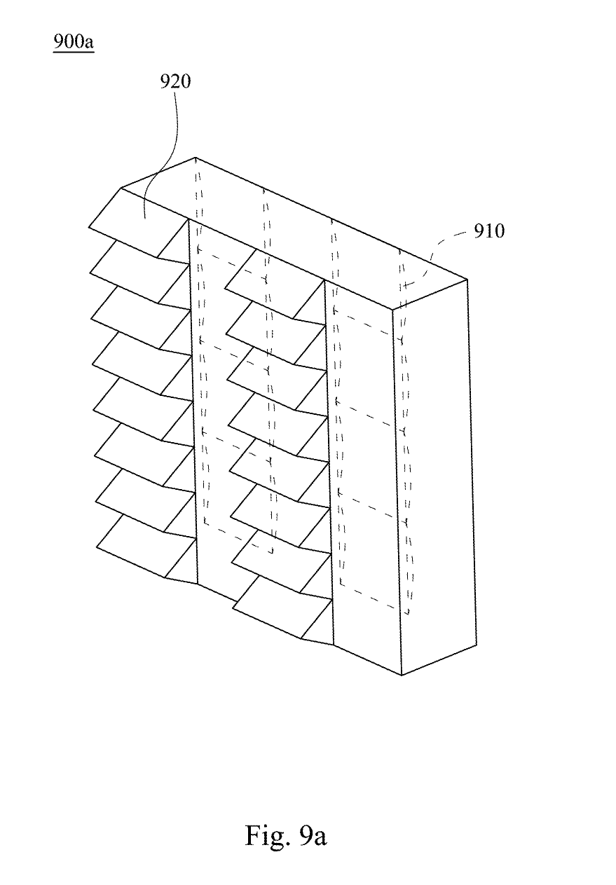

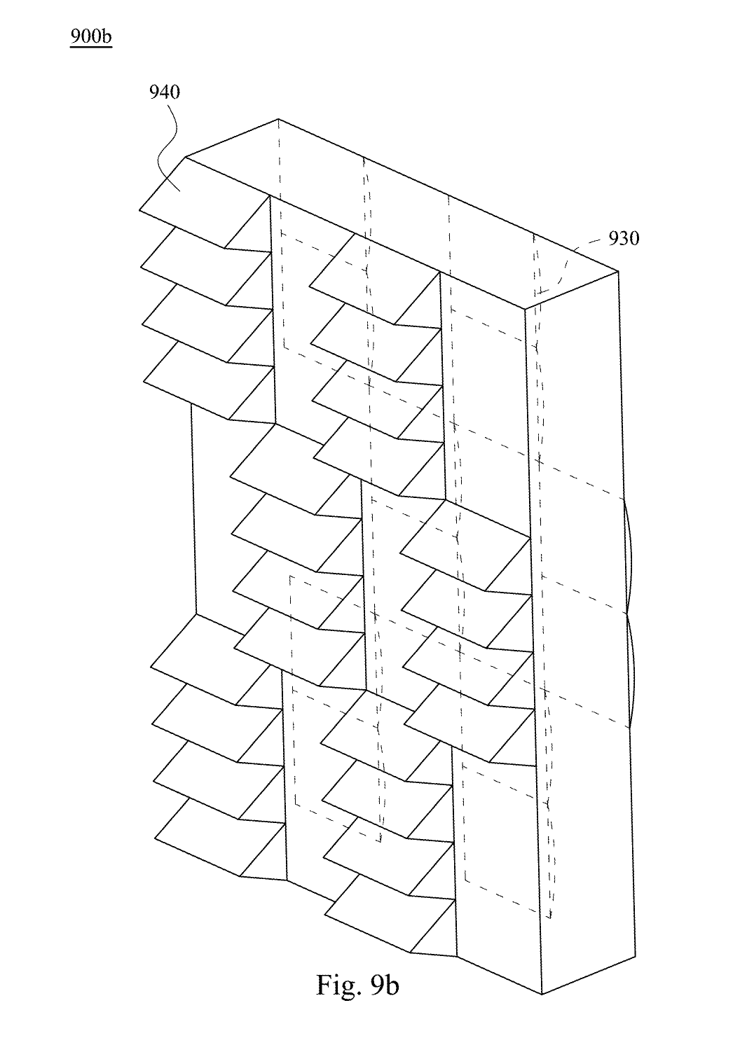

Referring to FIG. 9a, a schematic diagram of a light adjusting film 900a of a preferred embodiment of the present invention is shown. The micro lens structures 910 and the micro triangular prism structures 920 are arranged correspondingly, and are in a stripe pattern on the opposite sides of the transparent substrate.

Referring to FIG. 9b, a schematic diagram of a light adjusting film 900b of a preferred embodiment of the present invention is shown. The micro lens structures 930 and the micro triangular prism structures 940 are arranged correspondingly, and are arranged in a chessboard-like pattern on the opposite sides of the transparent substrate.

The light adjusting films of the present invention are manufactured by various methods, which would be known to the person skilled in the art, such as embossing, extrusion, molding and injection molding. One method of embossing, can be but not limited such as, for example, is that coating a curable resin on one side of the transparent substrate, embossing the curable resin with a predetermined pattern to form a plurality of microstructures on the transparent substrate, curing the plurality of microstructures on the transparent substrate, and repeating the steps described above on the other side of the transparent substrate so as to manufacture the light adjusting film of the present invention. The light adjusting performance of the present invention can be provided by the combination of the micro lens structures and the micro triangular prism structures, wherein the curvature of the micro lens structures is in the range of 50 μm⁻¹ to 500 μm⁻¹, and the position of each micro lens structure is corresponding to that of one or more triangular prism structures.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light adjusting film, comprising:
a transparent substrate;
a plurality of micro lens structures disposed on a light incident surface of the transparent substrate; and
a plurality of micro triangular prism structures disposed on a light emitting surface of the transparent substrate,
wherein the curvature of the micro lens structures is in the range of 50 μm⁻¹ to 500 μm⁻¹, and the position of each micro lens structure is corresponding to that of one or more micro triangular prism structures.

2. The light adjusting film according to claim 1, wherein the micro lens structures are formed of micro lenticular lenses, a micro lens array or a combination thereof.

3. The light adjusting film according to claim 2, wherein the micro lens array is a linear array, a curved array or the combination thereof.

4. The light adjusting film according to claim 1, wherein the width of the micro lens structures is in the range of 10 μm to 500 μm, and the height of the micro lens structures is in the range of 0.025 μm to 70 μm.

5. The light adjusting film according to claim 1, wherein each of the micro triangular prism structures has a first side and a second side, and a first included angle between the first side of the triangular prism structures and the transparent substrate is in the range of 40 degree to 90 degree.

6. The light adjusting film according to claim 5, wherein a second included angle between the first side and the second side of the micro triangular prism structures is in the range of 20 degree to 60 degree.

7. The light adjusting film according to claim 1, wherein the width of the micro triangular prism structures is in the range of 10 μm to 500 μm, and the height of the micro triangular prism structures is in the range of 1 μm to 1500 μm.

8. The light adjusting film according to claim 1, wherein each of micro lens structures is the same or different, and each of micro triangular prism structures is the same or different.

9. The light adjusting film according to claim 1, wherein the micro lens structures or the micro triangular prism structures are arranged continuously or discontinuously.

10. The light adjusting film according to claim 1, wherein the micro lens structures and the triangular prism structures are made of a material selected from the group consisting of a thermo curable material or a UV curable material and a combination thereof.

11. The light adjusting film according to claim 10, wherein the material further includes an IR absorber, an UV absorber, an antifouling agent, an antibacterial agent or a combination thereof.

12. The light adjusting film according to claim 1, wherein the micro lens structures or the micro triangular prism structures further comprise a coating layer disposed on the surface of the micro lens structures or on the triangular prism structures.

13. The light adjusting film according to claim 12, wherein the coating layer is a functional layer selected from the group consisting of an adhesive layer, a hard coating layer, a low energy surface coating layer, an IR absorbing layer, an UV absorbing layer and a combination thereof.
